(19) United States
(12) Patent Application Publication
(10) Pub. No.: US 2026/0358138 A1
(43) Pub. Date: Nov. 12, 2026

(54) METHODS AND SYSTEMS FOR DYNAMIC SCENE RECONSTRUCTION IN ONLINE MAPPING PRE-TRAINING AND SENSOR GENERALIZATION

(71) Applicant: Robert Bosch GmbH, Stuttgart (DE)

(72) Inventors: David Fernando PAZ RUIZ, Sunnyvale, CA (US); Hengyuan ZHANG, San Diego, CA (US); Yuliang GUO, Redwood City, CA (US); Xinyu HUANG, San Jose, CA (US); Liu REN, Saratoga, CA (US)

(21) Appl. No.: 19/202,073

(22) Filed: May 8, 2025

(51) Int. Cl. G01C 21/00; G05B 13/02; G06T 15/08; G06V 10/764; G06V 10/774; G06V 10/82; G06V 20/56

(52) U.S. Cl. CPC G01C 21/3841; G05B 13/0265; G06T 15/08; G06V 10/764; G06V 10/774; G06V 10/82; G06V 20/56

(57) ABSTRACT

Methods and systems for synthesizing sensor data for online mapping pre-training and sensor generalization addresses the challenge of adapting to different sensor configurations. A previously-generated sensor dataset is classified into dataset into static and dynamic object data, and volumetric scene reconstruction is executed to yield a four-dimensional scene representation. A new sensor dataset is synthesized by aligning the derived scene representation with new sensor specifications, thereby facilitating improved generalization and enhanced adaptability in autonomous driving systems.

### TECHNICAL FIELD

The present disclosure generally relates to autonomous driving technologies. In specific embodiments, the present disclosure relates to methods and systems for dynamic scene reconstruction and sensor data synthesis for online mapping pre-training and sensor generalization.

### BACKGROUND

In the realm of autonomous driving and advanced mapping systems, vehicles increasingly rely on complex sensor arrays to generate accurate, real-time depictions of their surroundings. Modern mapping approaches play a significant role in interpreting dynamic environments that encompass both stationary structures and transient elements, such as moving vehicles and pedestrians. However, the variability in sensor placement, calibration, and configuration across different platforms often results in heterogeneous data representations. These inconsistencies challenge the reliability of environmental modeling and hinder the seamless integration of sensor data into cohesive, actionable maps.

Existing methodologies that employ datasets generated under fixed sensor conditions often necessitate extensive manual intervention or rigid update protocols when accommodating new sensor configurations. This reliance can introduce delays and limit adaptability in rapidly changing conditions, where the dynamic nature of the environment demands swift and accurate mapping. Moreover, conventional methods may struggle to capture the full complexity of dynamic scenes, sometimes yielding models that fall short in terms of generalization and robustness. Harmonizing sensor data across varied configurations while ensuring high-fidelity environmental representations under diverse operating conditions is needed and is difficult.

### SUMMARY

In an embodiment, a method for synthesizing sensor data for online mapping pre-training and sensor generalization is provided. The method includes receiving a previously-generated sensor dataset associated with a scene, the dataset having been captured by a first plurality of sensors with associated sensor specifications; classifying the sensor data into static object data corresponding to static objects and dynamic object data corresponding to dynamic objects; executing volumetric scene reconstruction on the static and dynamic object data to generate a four-dimensional representation of the scene; generating a new sensor dataset for the scene comprising sensor data captured by a second plurality of sensors having sensor specifications differing from those of the first plurality; and synthesizing the new sensor dataset by aligning the four-dimensional representation to the new sensor specifications to produce a synthesized dataset, wherein in some embodiments the synthesis further includes operations such as rasterization to convert the four-dimensional representation into a two-dimensional format, diffusion to smooth and interpolate the rasterized data, and optionally flow-matching to align a flow of data points, with some embodiments incorporating the generation of a four-dimensional simulation of the scene and utilizing previously-generated sensor datasets that include spatio-temporal data captured by cameras, LiDAR, or radar sensors.

In an embodiment, a system for synthesizing sensor data for online mapping pre-training and sensor generalization is provided. The system includes storage configured to store a previously-generated sensor dataset associated with a scene, a second plurality of sensors positioned about a vehicle, and a processor coupled to the storage and the sensors; the processor being programmed to receive the previously-generated sensor dataset; process the sensor data to classify the data into static object data and dynamic object data; execute volumetric scene reconstruction on the classified data to generate a four-dimensional representation of the scene; generate a new sensor dataset associated with the scene wherein the new dataset is captured by the second plurality of sensors having sensor specifications that differ from those of the first plurality; and synthesize the new sensor dataset by aligning the four-dimensional representation to the new sensor specifications to produce a synthesized dataset. In various embodiments, the synthesis further includes rasterization to convert the four-dimensional representation into a two-dimensional format, diffusion to smooth and interpolate the rasterized data, flow-matching to align a flow of data points, the generation of a four-dimensional simulation of the scene, the update of an HD map, and in certain cases the operation of the system using previously-generated sensor datasets that include spatio-temporal data captured by cameras, LiDAR, or radar sensors.

In an embodiment, a non-transitory computer-readable medium is provided, the medium comprising instructions which, when executed by a processor, cause the processor to perform operations including receiving a previously-generated sensor dataset associated with a scene, the dataset having been captured by a first plurality of sensors with associated sensor specifications; classifying the sensor data into static object data and dynamic object data; executing volumetric scene reconstruction on the classified data to generate a four-dimensional representation of the scene; generating a new sensor dataset for the scene based on sensor data captured by a second plurality of sensors having sensor specifications that differ from those of the first plurality; and synthesizing the new sensor dataset by aligning the four-dimensional representation to the new sensor specifications to generate a synthesized dataset, wherein in certain embodiments the instructions further cause the processor to update an HD map and control the movement of a vehicle based on the synthesized dataset.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 shows a system-level overview of a system of sensor data synthesis designed for online mapping pre-training and sensor generalization, according to an embodiment.

FIG. 4 shows a method for synthesizing sensor data for online mapping pre-training and sensor generalization, according to an embodiment.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In the realm of autonomous driving, the generation and maintenance of high-definition (HD) maps are important for enabling precise navigation and decision-making. These maps provide detailed representations of the environment, including road layouts, traffic signs, and other significant elements. However, the dynamic nature of urban and highway environments poses substantial challenges to maintaining the accuracy and relevance of these maps. Construction activities, changes in traffic patterns, and the presence of dynamic objects such as vehicles and pedestrians can quickly render existing maps outdated, necessitating frequent updates. The traditional approach to updating HD maps involves manual labeling and validation, which is both time-consuming and resource-intensive, limiting scalability for widespread autonomous driving applications.

Recent advancements have sought to address these challenges by generating maps on-the-fly using camera data, thereby reducing reliance on manually labeled maps. However, these online methods face a significant limitation: the lack of generalization across different sensor configurations. An online map model trained under one sensor setup may not perform optimally when applied to a different setup, hindering the adaptability of autonomous systems across various vehicle platforms. This limitation underscores the need for a method that can synthesize data specifically tailored to new or specific sensor configurations, ensuring consistent performance regardless of the sensor setup.

The present framework introduces a novel approach for 3D/4D dynamic scene reconstruction that significantly enhances the generalization capabilities of vision-driven online map generation architectures. By processing sequences of driving data with spatio-temporal continuity, the framework reconstructs both static and dynamic components of the scene using multiple cameras and optional LiDAR data. Static components include large and small structures such as buildings, drivable regions, and road signage, while dynamic components encompass moving objects like vehicles and pedestrians. The framework employs advanced techniques such as Gaussian Splatting and diffusion/flow matching to synthesize new perspectives of the scene, accommodating different sensor configurations. This synthetic data regeneration approach enables scene synthesis from various perspectives, facilitating online map model generalization, model pre-training, and training data performance enhancements.

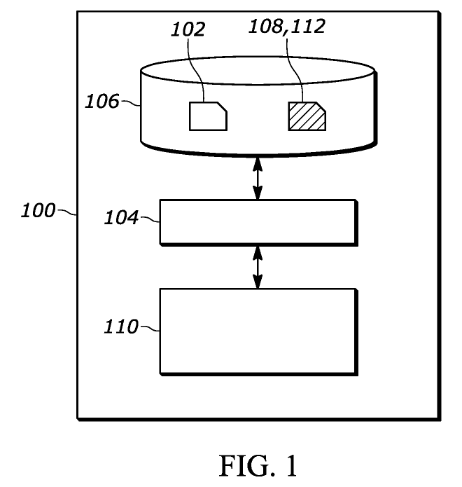

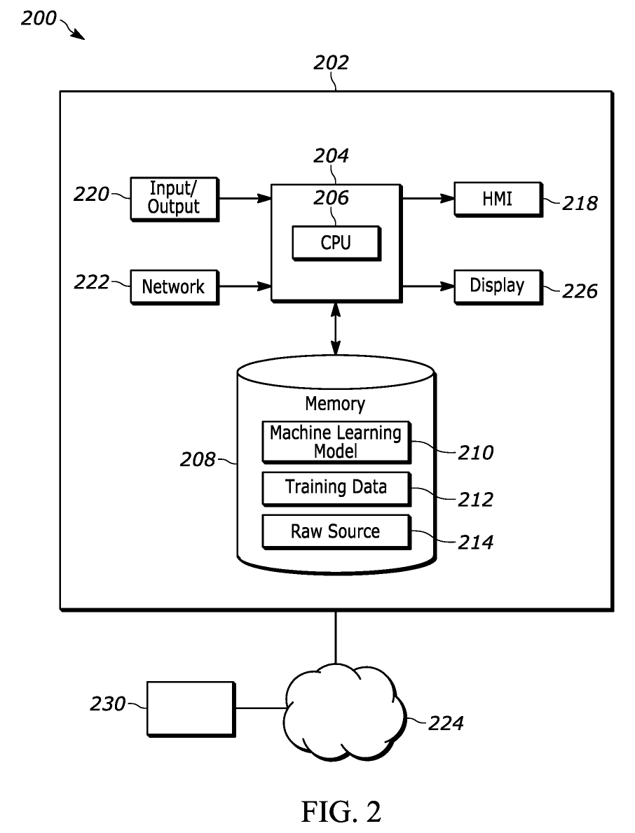

Machine-learning model training and pre-training is benefited by the teachings of the present disclosure. The following description regarding FIGS. 1-2 provides a general introduction to machine learning techniques that are relevant to the methods for utilizing machine learning models, such as those described herein.

FIG. 1 illustrates a system 100 for training and utilizing a machine learning model, such as a convolutional neural network, according to some embodiments. It should be understood that, while the example embodiments given in the following paragraphs herein with regard to FIGS. 1 and 2 refer to a convolutional neural network, additional embodiments of FIGS. 1 and 2 may be applied to any other type of neural-network-based or non-neural-network-based machine learning model that is configured to be developed, trained, fine-tuned, and/or executed for various applications of audio tracking and interpretation that are further described herein.

In some embodiments, the system 100 may comprise an input interface for accessing training dataset 102 for the convolutional neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the pre-trained convolutional neural network may also each be accessed from a different data storage, e.g., via a different subsystem of the data storage interface 104. Each subsystem may be of a type as is described above for the data storage interface 104. In other embodiments, the data representation 108 of the pre-trained convolutional neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the convolutional neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train and/or fine-tune the convolutional neural network using the training data 102 (e.g., thus generating updated versions of the machine learning model with respect to a first “pre-trained” version of the model). Here, an iteration of the training by the processor subsystem 110 may comprise a forward propagation part and a reverse, or generation, propagation part.

The system 100 may further comprise an output interface for outputting a data representation 112 of the trained convolutional neural network, and this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘pre-trained’ convolutional neural network may during or after the training be replaced, at least in part by the data representation 112 of the trained neural network, in that the parameters of the convolutional neural network, such as weights, hyperparameters, and other types of parameters of convolutional neural networks, may be adapted to reflect the training on the training data 102. This is also illustrated in FIG. 1 by the reference numerals 108 and 112 referring to the same data record on the data storage 106. In other embodiments, the data representation 112 may be stored separately from the data representation 108 defining the ‘pre-trained’ convolutional neural network. In some embodiments, the output interface may be separate from the data storage interface 104, but may in general be of a type as described above for the data storage interface 104.

The system 100 shown in FIG. 1 is one example of a system that may be utilized to train and then subsequently execute trained machine learning models, such as those described herein.

FIG. 2 illustrates a computer-implemented system for training, pre-training, and/or utilizing a model such as a convolutional neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206 and, in some embodiments, a graphics processing unit (GPU). The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

In embodiments, a GPU can be relied upon for training, pre-training, and utilizing models such as convolutional neural networks. The GPU is particularly well-suited for handling the parallel processing demands of training complex machine learning models, offering significant performance advantages over traditional CPUs. By utilizing the GPU, the system can efficiently manage the large-scale computations required for processing high-dimensional data and executing advanced algorithms. The GPU’s architecture allows for simultaneous execution of multiple operations, which accelerates the training process and enhances the system’s ability to handle extensive datasets. This capability enables rapid iteration and refinement of models, leading to improved accuracy and performance in real-time applications. The integration of GPU resources within the computing system 202 ensures that the system can meet the computational demands of modern machine learning tasks, providing a robust platform for developing and deploying advanced autonomous driving technologies.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 214, etc.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 214. The raw source dataset 214 may include raw or unprocessed sensor data that may be representative of an input dataset for a machine learning system. For example, the raw source dataset 214 may include data gathered by vehicle sensors for constructing a 3D/4D representation of a scene, according to the teachings provided herein. In some examples, the machine learning algorithm 210 may be a convolutional neural network algorithm that is designed to perform a predetermined function. For example, the neural network algorithm may be configured to receive audio segments and text-based event descriptions.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a convolutional neural network algorithm. The training dataset 212 may include a set of source data that has corresponding outcomes or results that the machine learning algorithm 210 tries to duplicate via the learning process. In examples, the training dataset 212 may include previously-stored data from vehicle sensors, wherein the previously-stored data is reflective of, or describes, objects about the vehicle as detected by the sensors (e.g., position, velocity, orientation, etc.).

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 214. The raw source data 214 may include a plurality of instances or input dataset for which annotation results are desired. The machine learning algorithm 210 may be programmed to process the raw source data 214 to identify the presence of the particular features. The machine learning algorithm 210 may be configured to identify a feature in the raw source data 214 as a predetermined feature. The raw source data 214 may be derived from a variety of sources. For example, the raw source data 214 may be actual input data collected by a machine learning system.

In the context of the present invention, the machine learning system described in FIGS. 1-2 is one example of a system for processing and utilizing camera data for dynamic scene reconstruction. The exemplary system, as depicted in FIG. 2, allows for the input of camera data through the input interface, which is then processed by the processor 204 to generate a dynamic reconstruction of the scene. This process involves accessing the original online mapping sensor dataset as well as the original sensor specifications from storage 208. By leveraging these datasets, the system can adaptively synthesize new sensor data that aligns with the new sensor specifications 312, ensuring that the reconstructed scene is accurately represented across different sensor configurations. This capability enhances the generalization and adaptability of the online map generation architecture, allowing for improved performance in autonomous driving applications.

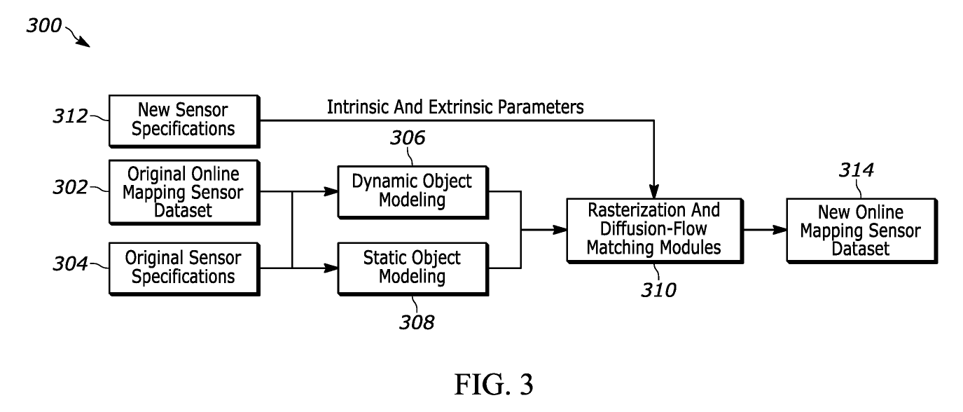

FIG. 3 illustrates a system-level overview of a system of sensor data synthesis designed for online mapping pre-training and sensor generalization, according to an embodiment. The system is structured to process sensor datasets, such as the Original Online Mapping Sensor Dataset 302, and generate new sensor data aligned with different sensor specifications, including the New Sensor Specifications 312. The system comprises several components, including Dynamic Object Modeling 306, Static Object Modeling 308, and Rasterization and Diffusion - Flow Matching Modules 310, culminating in the production of a New Online Mapping Sensor Dataset 314.

The Original Online Mapping Sensor Dataset 302 serves as the foundational input for the system, comprising sensor data captured by a first set of sensors. This dataset includes detailed information about the scene, providing the necessary data for subsequent processing and modeling. This dataset 302 can be referred to as a previously-generated sensor dataset associated with the scene. This dataset 302 also comprises sensor data captured by a first plurality of sensors, which can include one or more of the following: cameras, LiDAR sensors, Radar sensors, ultrasonic sensors, inertial measurement unit (IMU) sensors, and the like.

Accompanying this dataset are the Original Sensor Specifications 304, which include the intrinsic and extrinsic parameters of the first plurality of sensors used to capture the original data. The intrinsic parameters describe the internal characteristics of the sensors, such as focal length, optical center, and lens distortion coefficients. For example, the focal length determines the field of view of a camera, while the optical center indicates the point where light rays converge on the sensor. Lens distortion coefficients account for any warping effects caused by the lens, ensuring that the captured images are accurately corrected for geometric distortions. These intrinsic parameters are for calibrating the sensors and ensuring that the data they capture is precise and reliable. The extrinsic parameters refer to the spatial positioning and orientation of the sensors relative to a fixed reference frame, such as the vehicle or platform on which they are mounted. For instance, the extrinsic parameters can include the translation and rotation vectors that describe the sensor's location and angle relative to the vehicle's coordinate system. This information is for aligning and integrating data from multiple sensors, allowing for a cohesive and comprehensive representation of the scene. By accurately defining both intrinsic and extrinsic parameters, the original sensor specifications 304 enable the system to interpret the sensor data with high fidelity, ensuring that the reconstructed scene accurately reflects the real-world environment. This detailed specification allows for tasks such as sensor fusion, where data from different sensors must be combined to create a unified view of the scene, and for adapting the data to new sensor configurations in the synthesis process.

The original sensor data 302 and original sensor specifications 304 allow for classification of sensor data into static and dynamic object data. Utilizing the intrinsic and extrinsic specifications, the system can distinguishing between static and dynamic elements based on their spatial and temporal characteristics. Static object data can be identified by analyzing the consistent spatial properties and fixed positions of objects such as buildings, road signage, and drivable regions, which remain unchanged over time. In contrast, dynamic object data can be characterized by variations in position, velocity, and orientation, indicative of objects like vehicles and pedestrians that exhibit movement and interaction within the scene. By leveraging the detailed sensor specifications 304, the system can effectively classify the sensor data, ensuring that both static and dynamic components are accurately classified and represented in the subsequent modeling processes. This classification allows for constructing a reliable and comprehensive four-dimensional representation of the scene, which serves as the foundation for further synthesis and alignment with new sensor configurations.

Along these lines, the system 300 can employ dynamic object modeling 306, representing a model responsible for classifying and reconstructing dynamic objects within the scene, such as vehicles and pedestrians. This model can be trained to operate as a tuned machine learning model according to the teachings provided above. This model leverages the intrinsic properties of dynamic objects, such as their shape, size, and color, along with extrinsic parameters like their position and orientation relative to the sensors, to create a detailed and accurate model of their movement. By continuously tracking these parameters, the module can simulate the objects' interactions with the environment and other objects, capturing their dynamic behavior over time. This allows for precise modeling of complex scenarios, such as traffic flow and pedestrian movement, which are critical for realistic scene reconstruction and autonomous navigation.

In contrast, static object modeling 308 is a model configured for reconstructing static elements within the scene, such as buildings, road signage, and drivable regions. This model employs advanced algorithms to analyze and interpret the spatial data associated with these static objects, ensuring that their geometric shapes, spatial orientations, and surface properties are precisely captured. By maintaining a detailed and consistent representation of these static elements, the model provides a stable reference framework that supports the dynamic components of the scene. This stability assists the overall scene reconstruction, as it allows dynamic objects to be accurately positioned and tracked relative to the static environment, thereby enhancing the reliability and accuracy of the synthesized scene data. Additionally, the static object modeling contributes to the system's ability to handle occlusions and maintain continuity in the scene, which is essential for applications such as autonomous navigation and real-time mapping.

The static object modeling 308 and dynamic object modeling 306 components collectively contribute to outputting a four-dimensional representation of the scene. A "four-dimensional" representation of the scene refers to a model that incorporates both spatial and temporal dimensions to provide a comprehensive depiction of the environment, which is rooted in dynamic object modeling 306.

The system 300 then proceeds with rasterization and diffusion and flow matching models 310. This can be more generally referred to as a synthesizing model at 310, whereby the four-dimensional representation of the scene is aligned with the new sensor dataset. The models 310 are configured to transform the four-dimensional representation of the scene into a format compatible with the new sensor specifications 312. In embodiments, this transformation begins with rasterization, a process that converts volumetric data into a two-dimensional grid. By mapping the complex, multi-dimensional scene data onto a simpler 2D grid format, rasterization facilitates the alignment of the scene with the field of view and resolution of the new sensor setup. This step allows for ensuring that the synthesized data is accessible and interpretable by the new sensors, which may have different intrinsic and extrinsic parameters compared to the original sensor specifications. The rasterization process can account for variations in sensor resolution, field of view, and other specifications to ensure that the data is accurately represented in the new format.

Following rasterization, diffusion techniques, coupled with flow matching, are applied to the rasterized data to enhance its quality and consistency. Diffusion involves smoothing and interpolating the data, which helps to reduce artifacts and discontinuities that may arise during the rasterization process. This smoothing allows for maintaining the integrity of the scene representation, ensuring that transitions between different elements are seamless and realistic. Flow matching further refines this process by aligning the flow of data points, ensuring that the dynamic aspects of the scene are accurately captured and represented. Flow matching is a technique used to enhance the accuracy and consistency of data representation by aligning the flow of data points within a scene. In the context of synthesizing sensor data, flow matching ensures that the dynamic aspects of the scene, such as moving objects and changing environmental conditions, are accurately captured and represented. In embodiments, flow matching involves tracking data points (e.g., location, position, etc.) over time, identifying object's paths, and aligning them to create a coherent and continuous representation. This alignment allows for maintaining the temporal consistency of the scene, as it ensures that the movement of objects is represented smoothly and without abrupt changes or discontinuities. By aligning the flow of data points, flow matching helps to preserve the natural motion and interactions of dynamic elements, such as vehicles and pedestrians, within the scene. Additionally, flow matching aids in interpolating missing or sparse data points, filling gaps in the dataset to create a more complete and accurate representation of the scene. This process enhances the overall quality of the synthesized dataset, ensuring that it accurately reflects the dynamic nature of the environment and is well-suited for use in real-time applications.

By aligning the rasterized, diffused, and flow-matched data with the new sensor specifications 312, the system ensures that the synthesized dataset accurately reflects the scene as perceived by the new sensor setup. This alignment enables the system to adapt to different sensor configurations, enhancing its generalization capabilities and ensuring consistent performance across various platforms. The integration of these advanced techniques within the model 310 enables the system's ability to produce high-quality, adaptable sensor data for online mapping applications.

Finally, the New Online Mapping Sensor Dataset 314 represents the final output of the system, a synthesized dataset based on the alignment of the four-dimensional scene representation with the new sensor specifications. This dataset facilitates improved generalization and adaptability of online map generation architectures across different sensor setups, enhancing the robustness and performance of autonomous driving systems. By "online," this means the system is capable of processing and updating map data in real-time as new sensor information is received, allowing for immediate adaptation to changes in the environment and sensor configurations without the need for offline processing or manual intervention.

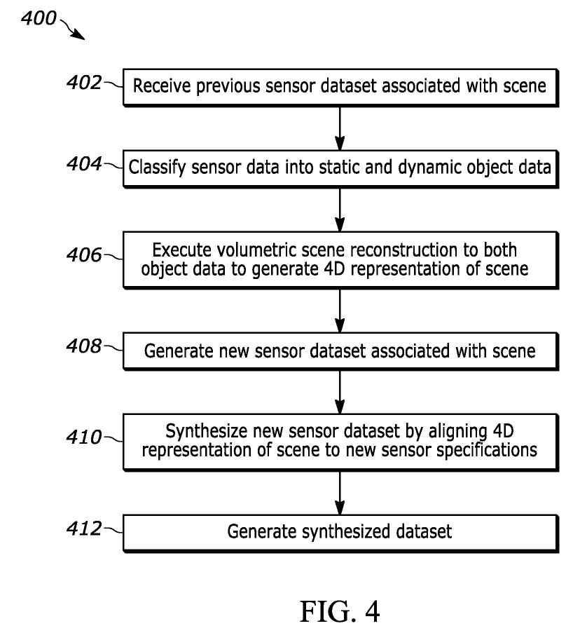

FIG. 4 shows a method for synthesizing sensor data for online mapping pre-training and sensor generalization. The method can be implemented by a system designed to process sensor datasets, such as the original online mapping sensor dataset 302 and the original sensor specifications 304, and generate synthesized data that aligns with new sensor specifications 312, enhancing the adaptability and performance of autonomous driving systems.

At step 402, the method involves receiving a previously-generated sensor dataset associated with a scene. This dataset comprises sensor data captured by a first plurality of sensors (e.g., camera, LiDAR, Radar, ultrasonic, IMU, etc.), providing detailed information about the scene for subsequent processing and modeling. This sensor data may have been saved in memory 208, for example as raw source data 214.

At step 404, the method includes classifying the sensor data into static object data and dynamic object data. Static object data is associated with objects that remain unchanged over time, such as buildings and road signage, while dynamic object data pertains to objects that exhibit movement, like vehicles and pedestrians.

At step 406, the method executes volumetric scene reconstruction on both static and dynamic object data to generate a four-dimensional representation of the scene. This representation incorporates spatial and temporal dimensions, providing a comprehensive depiction of the environment.

At step 408, the method includes generating a new sensor dataset 408 associated with the scene. This new dataset comprises sensor data captured by a second plurality of sensors, which have new sensor specifications 312 differing from those of the first plurality of sensors.

At step 410, the method includes synthesizing the new sensor dataset 408 by aligning the four-dimensional representation of the scene to the new sensor specifications 312. This alignment ensures that the synthesized dataset 412 accurately reflects the scene as perceived by the new sensor setup.

At step 412, the method generates a synthesized dataset based on the synthesis process. This dataset facilitates improved generalization and adaptability of online map generation architectures across different sensor setups, enhancing the robustness and performance of autonomous driving systems. Step 412 can be part of step 410, in that the synthesizing can generate the synthesized data.

Once the synthesized dataset is generated at step 412, it can serve several functions that enhance the capabilities of autonomous driving systems. The synthesized data can be particularly valuable for online mapping and navigation, providing a real-time, updated representation of the environment. This allows the autonomous vehicle to adapt to changes such as new obstacles, road conditions, or traffic patterns, ensuring safe and efficient navigation. By aligning the synthesized data with new sensor specifications, the dataset enables sensor generalization, allowing the autonomous system to perform consistently across different sensor configurations. This adaptability is essential for vehicles equipped with varying sensor setups. Furthermore, the synthesized dataset informs control algorithms and decision-making processes within the vehicle, providing accurate and up-to-date information about the environment to enhance safety and efficiency in maneuvers. It also supports predictive modeling, enabling the anticipation of future states of the environment, such as the movement of other vehicles or pedestrians, which is crucial for proactive planning and collision avoidance. Additionally, the synthesized data can be used in simulation environments to test and validate autonomous driving algorithms, ensuring that the vehicle's systems are robust and capable of handling a wide range of conditions.

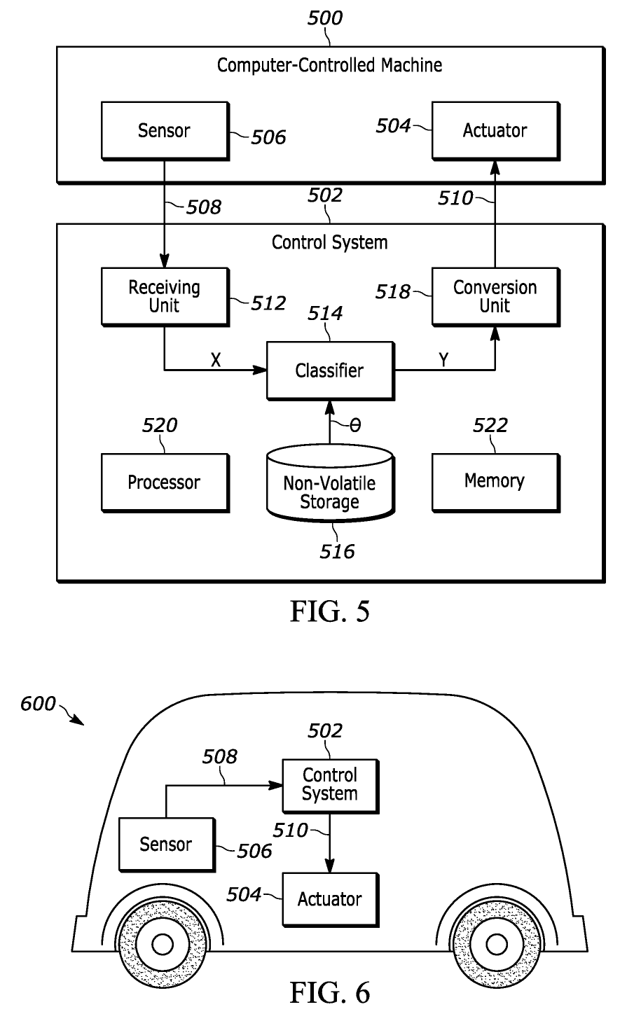

Structure used for training and using the machine-learning models for these applications (and other applications) are exemplified in FIG. 5. FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine-learning algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to FIGS. 1-3) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more machine-learning algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the machine-learning algorithms and/or methodologies as disclosed herein. Non-volatile storage 516 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control a vehicle 600, which may be an at least partially autonomous vehicle or an at least partially autonomous robot. In general, the synthesized data described above can be generated by vehicle 600 for online mapping purposes. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects. Classifier 514 may be embodied as classifying sensor data as associated with either a dynamic object or a static object, for example, among other functions.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

Rather than controlling the vehicle autonomously, the output of the system can be synthesized data that is used for updating an HD map. For example, the previously-generated data can be part of, or yield, an HD map, and the new data from the second plurality of sensors can be used (after synthesis) to updated the HD map in real-time. This can be beneficial for areas that the vehicle is traversing that has live changes, such as construction, parking spot availability, detours, and the like.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for synthesizing sensor data for online mapping pre-training and sensor generalization, the method comprising:
receiving a previously-generated sensor dataset associated with a scene, wherein the previously-generated sensor dataset comprises sensor data captured by a first plurality of sensors having associated sensor specifications;
classifying the sensor data into (i) static object data associated with static objects in the scene and (ii) dynamic object data associated with dynamic objects in the scene;
executing volumetric scene reconstruction to the static object data and the dynamic object data to generate a four-dimensional representation of the scene;
generating a new sensor dataset associated with the scene, wherein the new sensor dataset comprises new sensor data captured by a second plurality of sensors having new sensor specifications that differ from the sensor specifications associated with the first plurality of sensors;
synthesizing the new sensor dataset by aligning the four-dimensional representation of the scene to the new sensor specifications; and
generating a synthesized dataset based on the synthesizing.

2. The method of claim 1, wherein the synthesizing includes rasterization and diffusion.

3. The method of claim 2, wherein the rasterization includes converting the four-dimensional representation of the scene into a two-dimensional format that aligns with the new sensor specifications.

4. The method of claim 3, wherein the diffusion includes applying diffusion techniques to smooth and interpolate the rasterized data.

5. The method of claim 2, wherein the synthesizing further includes: flow-matching, including aligning a flow of data points within the scene.

6. The method of claim 1, further comprising generating a four-dimensional simulation of the scene based on the synthesized dataset.

7. The method of claim 1, wherein the previously-generated sensor dataset includes spatio-temporal data.

8. The method of claim 1, wherein the first plurality of sensors includes a camera, LiDAR, or radar sensor.

9. A system for synthesizing sensor data for online mapping pre-training and sensor generalization, the system comprising:
storage that stores a previously-generated sensor dataset associated with a scene, wherein the previously-generated sensor dataset comprises sensor data captured by a first plurality of sensors having associated sensor specifications;
a second plurality of sensors positioned about a vehicle; and
a processor communicatively connected to the second plurality of sensors and programmed to:
receive the previously-generated sensor dataset,
process the sensor data to determine (i) static object data associated with static objects in the scene and (ii) dynamic object data associated with dynamic objects in the scene,
execute volumetric scene reconstruction to the static object data and the dynamic object data to generate a four-dimensional representation of the scene,
generate a new sensor dataset associated with the scene, wherein the new sensor dataset comprises new sensor data captured by the second plurality of sensors having new sensor specifications that differ from the sensor specifications associated with the first plurality of sensors,
synthesize the new sensor dataset to generate a synthesized dataset by aligning the four-dimensional representation of the scene to the new sensor specifications.

10. The system of claim 9, wherein the synthesizing of the new sensor dataset includes rasterization and diffusion.

11. The system of claim 10, wherein the rasterization includes converting the four-dimensional representation of the scene into a two-dimensional format that aligns with the new sensor specifications.

12. The system of claim 11, wherein the diffusion includes applying diffusion techniques to smooth and interpolate the rasterized data.

13. The system of claim 10, wherein the synthesizing of new sensor dataset further includes: flow-matching, including aligning a flow of data points within the scene.

14. The system of claim 9, wherein the processor is further programmed to generate a four-dimensional simulation of the scene based on the synthesized dataset.

15. The system of claim 9, wherein the previously-generated sensor dataset includes spatio-temporal data.

16. The system of claim 9, wherein the first plurality of sensors includes a camera, LiDAR, or radar sensor.

17. The system of claim 9, wherein the processor is further programmed to generate an updated HD map based on the synthesized data.

18. A non-transitory computer-readable medium comprising instructions that, when executed by a processor, cause the processor to perform the following steps:
receiving a previously-generated sensor dataset associated with a scene, wherein the previously-generated sensor dataset comprises sensor data captured by a first plurality of sensors having associated sensor specifications;
classifying the sensor data into (i) static object data associated with static objects in the scene and (ii) dynamic object data associated with dynamic objects in the scene;
executing volumetric scene reconstruction to the static object data and the dynamic object data to generate a four-dimensional representation of the scene;
generating a new sensor dataset associated with the scene, wherein the new sensor dataset comprises new sensor data captured by a second plurality of sensors having new sensor specifications that differ from the sensor specifications associated with the first plurality of sensors;
synthesizing the new sensor dataset by aligning the four-dimensional representation of the scene to the new sensor specifications; and
generating a synthesized dataset based on the synthesizing.

19. The non-transitory computer-readable medium of claim 18, wherein the instructions, when executed by the processor, further cause the processor to:
update an HD map based on the synthesized dataset.

20. The non-transitory computer-readable medium of claim 18, wherein the instructions, when executed by the processor, further cause the processor to:
control movement of a vehicle based on the synthesized dataset.
